(19) United States
(12) Patent Application Publication
(10) Pub. No.: US 2026/0093746 A1
(43) Pub. Date: Apr. 2, 2026

(54) METHOD AND SERVER FOR PROVIDING EMAIL DATA

(71) Applicant: Y.E. Hub Armenia LLC, Yerevan (AM)

(72) Inventors: Ruslan DIUSAEV, Moscow (RU); Anton PROTSENKO, Moscow (RU); Dmitrii POTAPOV, Moscow (RU)

(21) Appl. No.: 19/346,366

(22) Filed: Sep. 30, 2025

(30) Foreign Application Priority Data
Sep. 30, 2024 (RU) 2024129089

(51) Int. Cl. G06F 16/34; G06F 16/35; G06Q 10/107; H04L 51/08

(52) U.S. Cl. CPC G06F 16/345; G06F 16/35; G06Q 10/107; H04L 51/08

(57) ABSTRACT

Methods and systems of providing email data. The method includes the steps of acquiring an email associated with an email account of a user, generating by a first model a prediction value indicative of a likelihood of the user to perform a user action on the email, the user action being of a given type, the DSSM has been trained on the given type of user actions, generating, by using a second model on the prediction value and the user content, a classification value indicative of a class of the email, the class being one of a high importance class and a low importance class. If the class value for the email is indicative of the high importance class, the method includes generating, using a generative model, an email summary of the email content, and triggering display of the email summary on the user device.

### CROSS-REFERENCE

The present application claims priority to Russian Patent Application No. 2024129089, entitled “Method and Server for Providing Email Data”, filed Sep. 30, 2024, the entirety of which is incorporated herein by reference.

### FIELD

The present technology generally relates to e-mail services, and, in particular, to methods and systems for determining a spam prediction error parameter.

### BACKGROUND

“Emails” is an important medium for digital communication, with large platforms such as Gmail™, Microsoft Outlook™, Apple Mail™, Yandex Mail™, for example. These platforms offer many features, including message filtering, calendar integration, and search functions. They are available across devices, helping users to access their emails at any time and from any location.

Recent advancements have included the integration of Artificial Intelligence (AI) and Machine Learning (ML) tools to help with composing emails, organizing inboxes, and detecting spam. Some platforms have also introduced tools to enhance speed, introduce better workflow customization, and prioritize privacy and usability.

However, as email use has grown, so too have the problems associated with it. One challenge associated with increasing email use is “email overload”, which presents both human and technical difficulties. As a result, while email services are important communication tools, its evolving technical demands necessitate ameliorated solutions to keep up with the increasing volume, complexity, and/or security requirements.

### SUMMARY

It is an object of the present technology to improve at least one drawback associated with the relevant prior art.

It should be noted that email users may spend hours managing their inboxes daily, disrupting workflow and reducing productivity. The continuous influx of emails demands attention, causing frequent interruptions. Also, many emails are irrelevant, complicating the process of finding important emails among spam, newsletters, and promotions. This can result in missed important emails, delayed responses, and/or miscommunications. Frequent email alerts also distract users, decreasing focus and efficiency and leading to mental fatigue.

It should also be noted that as email volume increases, so does the need for scalable infrastructure. Developers of the present technology have realized that email servers may need to handle large numbers of incoming and outgoing emails, all while provide rapid delivery, security, and/or reliability. This may particularly be difficult to achieve for large organizations, the email servers of which handle thousands of users and millions of emails per day, for example.

It should also be noted that the growing size of attachments and rich media in emails has put significant pressure on storage capacity and/or bandwidth. Developers of the present technology have realized that email servers may need considerable storage resources to archive emails and/or to handle the increasing file sizes that accompany email communications.

Although spam filters and security protocols have become more advanced, they still face significant challenges. Cyber threats such as phishing, malware, and spoofing attacks are often delivered via email, requiring increasingly sophisticated detection algorithms to prevent unauthorized access or harmful content from reaching users.

AI and ML models used to categorize emails (e.g., sorting them into promotional, social, or priority folders) face difficulties in correctly identifying email types. Misclassifications can result in important emails being misplaced or delayed, contributing to poor user experience.

With increasing email traffic, maintaining low-latency email delivery may be desired but challenging, especially during peak times or when handling large “attachment-heavy” emails. Email queuing and routing need to be optimized to ensure timely delivery.

Additionally, keeping emails synchronized across multiple devices (e.g., smartphones, laptops, tablets) while ensuring that changes, such as deleted or read emails, for example, are accurately reflected in real-time can strain server resources and lead to inconsistencies.

Furthermore, ensuring that emails, particularly sensitive information, are adequately encrypted and/or protected from unauthorized access presents a technical challenge. Email providers may be required to meet stringent data privacy standards, which in turn require more robust encryption techniques.

In some aspects of the present technology, there is provided a method of providing email data, the method executable by a server communicatively coupled with a user device, the method comprising: acquiring an email associated with an email account of a user, the server having access to email content of the email and user content of the user; generating, by using a Deep Structured Semantic Model (DSSM) on the email content, a prediction value indicative of a likelihood of the user to perform a user action on the email, the user action being of a given type, the DSSM has been trained on the given type of user actions; generating, by using a GBDT model on the prediction value and the user content, a classification value indicative of a class of the email, the class being one of a high importance class and a low importance class; if the class value for the email is indicative of the high importance class: generating, using a generative model, an email summary of the email content; and triggering display of the email summary on the user device. This is a part of natural language processing (NLP) routine. At least some of the embodiments may allow increasing quality of the important email detection.

In some embodiments of the method, the method further comprises storing the email summary for display of the email summary to the user. At least some of the embodiments may allow increasing speed of the email summary generation.

In some embodiments of the method, the email content comprises at least one of an email body, an email title, an email attachment.

In some embodiments of the method, the email summary comprises a summary of the email attachment, and wherein the triggering display of the email summary is executed prior to transmitting the email attachment to the user device.

In some embodiments of the method, the given type of user actions comprises at least one of reading the email, labelling the email as spam, labelling the email as favorite, opening an attachment, clicking a link in the email.

In some embodiments of the method, the user content comprises a user embedding generated based on user behavioral data.

In some embodiments of the method, the method further comprises: generating, by using an other DSSM on the email content, an other prediction value indicative of a likelihood of the given user to perform an other user action on the email, the other user action being of an other given type, the given type being different from the other given type, the other DSSM has been trained on the other given type of user actions instead of the given type of user actions; and wherein the generating the classification value further comprises generating the classification further using the other prediction value.

In some embodiments of the method, the generating the classification value further comprises generating the classification further using at least one of rule-based and counter-based indicators generated based on the email content.

In some embodiments of the method, the method further comprises: acquiring a second email associated with the email account of the user, the server having access to second email content of the second email and the user content of the user; generating, by using the DSSM on the second email content, a second prediction value indicative of a likelihood of the user to perform the user action on the second email, the user action being of the given type, the generating the second prediction value for the second email being performed independently form the generating the prediction value for the email; generating, by using a GBDT model on the second prediction value and the user content, a second classification value indicative of a class of the second email, the generating the second classification value for the second email being executed independently from the generating the classification value for the email; if the class value for the second email is indicative of the high importance class: generating, using the generative model, a second email summary of the second email content; and triggering display of the second email summary on the user device.

In some embodiments of the method, the generative model is a Generative Pre-Trained Transformer (GPT) model.

In some aspects of the present technology, there is provided a server for providing email data, the server communicatively coupled with a user device, the server being configured to: acquire an email associated with an email account of a user, the server having access to email content of the email and user content of the user; generate, by using a Deep Structured Semantic Model (DSSM) on the email content, a prediction value indicative of a likelihood of the user to perform a user action on the email, the user action being of a given type, the DSSM has been trained on the given type of user actions; generate, by using a GBDT model on the prediction value and the user content, a classification value indicative of a class of the email, the class being one of a high importance class and a low importance class; if the class value for the email is indicative of the high importance class: generate, using a generative model, an email summary of the email content; and trigger display of the email summary on the user device.

In some embodiments of the server, the server is configured to: store the email summary for display of the email summary to the user.

In some embodiments of the server, the email content comprises at least one of an email body, an email title, an email attachment.

In some embodiments of the server, the email summary comprises a summary of the email attachment, and wherein the triggering display of the email summary is executed prior to transmitting the email attachment to the user device.

In some embodiments of the server, the given type of user actions comprises at least one of reading the email, labelling the email as spam, labelling the email as favorite, opening an attachment, clicking a link in the email.

In some embodiments of the server, the user content comprises a user embedding generated based on user behavioral data.

In some embodiments of the server, the server is configured to: generate, by using an other DSSM on the email content, an other prediction value indicative of a likelihood of the given user to perform an other user action on the email, the other user action being of an other given type, the given type being different from the other given type, the other DSSM has been trained on the other given type of user actions instead of the given type of user actions; and wherein to generate the classification value further comprises the server configured to generate the classification further using the other prediction value.

In some embodiments of the server, to generating the classification value further comprises the server configured to generate the classification further using at least one of rule-based and counter-based indicators generated based on the email content.

In some embodiments of the server, the server is configured to: acquire a second email associated with the email account of the user, the server having access to second email content of the second email and the user content of the user; generate, by using the DSSM on the second email content, a second prediction value indicative of a likelihood of the user to perform the user action on the second email, the user action being of the given type, the generating the second prediction value for the second email being performed independently form the generating the prediction value for the email; generate, by using a GBDT model on the second prediction value and the user content, a second classification value indicative of a class of the second email, the generating the second classification value for the second email being executed independently from the generating the classification value for the email; if the class value for the second email is indicative of the high importance class: generate, using the generative model, a second email summary of the second email content; and trigger display of the second email summary on the user device.

In some embodiments of the server, the generative model is a Generative Pre-Trained Transformer (GPT) model which is also a part of natural language processing (NLP) techniques.

In the context of the present specification, a “server” is a computer program that is running on appropriate hardware and is capable of receiving requests (e.g. from electronic devices) over the network, and carrying out those requests, or causing those requests to be carried out. The hardware may be one physical computer or one physical computer system, but neither is required to be the case with respect to the present technology. In the present context, the use of the expression a “at least one server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, unless provided expressly otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended to imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

In the context of the present specification, unless provided expressly otherwise, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

### DESCRIPTION OF THE DRAWINGS

For a better understanding of the present technology, as well as other aspects and further features thereof, reference is made to the following description which is to be used in conjunction with the accompanying drawings, where:

FIG. 1 is a schematic diagram depicting a system, the system being implemented in accordance with non-limiting embodiments of the present technology;

FIG. 2 depicts a schematic illustration of operation of an email application of FIG. 1 including an email processing engine, in accordance with non-limiting embodiments of the present technology;

FIG. 3 depicts a Graphical User Interface (GUI) displayed by a user device of FIG. 1 including an email summary portion, in accordance with non-limiting embodiments of the present technology;

FIG. 4 is a schematic illustration of a training process of a GBDT model of the email processing engine of FIG. 2 for generating prediction values for specific type of user action, in accordance with non-limiting embodiments of the present technology;

FIG. 5 is a schematic illustration of a training process of a DSSM model of the email processing engine of FIG. 2 for generating prediction values for specific type of user action, in accordance with non-limiting embodiments of the present technology;

FIG. 6 is a schematic illustration of a method executable by a server of FIG. 1, in accordance with non-limiting embodiments of the present technology.

### DETAILED DESCRIPTION

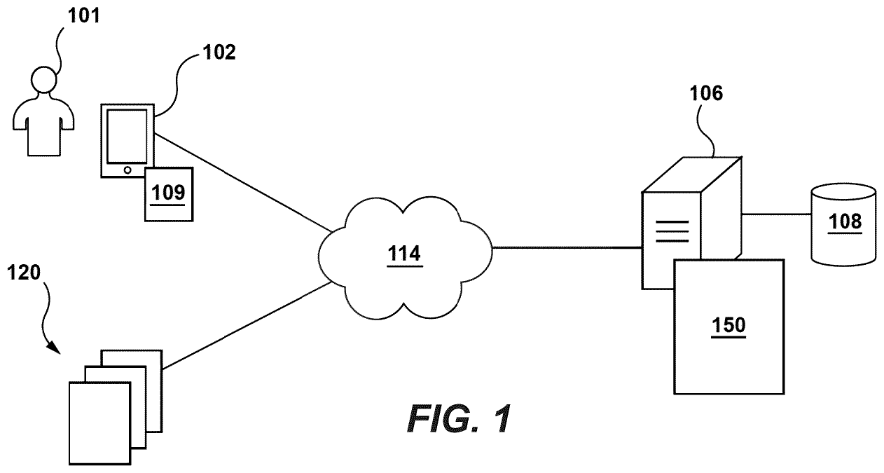

Referring to FIG. 1, there is shown a schematic diagram of a system 100, the system 100 being suitable for implementing non-limiting embodiments of the present technology. It is to be expressly understood that the system 100 is depicted merely as an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition, it is to be understood that the system 100 may provide in certain instances simple implementations of the present technology, and that where such is the case they have been presented in this manner as an aid to understanding. As persons skilled in the art would understand, various implementations of the present technology may be of a greater complexity.

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope. Furthermore, as an aid to understanding, the following description may describe relatively simplified implementations of the present technology. As persons skilled in the art would understand, various implementations of the present technology may be of greater complexity.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

With these fundamentals in place, we will now consider some non-limiting examples to illustrate various implementations of aspects of the present technology.

### Electronic Device

The system 100 comprises an electronic device 102. The electronic device 102 is associated with a user 101 and, as such, can sometimes be referred to as a “client device” or “user device”. It should be noted that the fact that the electronic device 102 is associated with the user does not mean to suggest or imply any mode of operation-such as a need to log in, a need to be registered or the like.

In the context of the present specification, unless provided expressly otherwise, “electronic device” is any computer hardware that is capable of running a software appropriate to the relevant task at hand. Thus, some (non-limiting) examples of electronic devices include personal computers (desktops, laptops, netbooks, etc.), smartphones, and tablets, as well as network equipment such as routers, switches, and gateways. It should be noted that a device acting as an electronic device in the present context is not precluded from acting as a server to other electronic devices. The use of the expression “an electronic device” does not preclude multiple client devices being used in receiving/sending, carrying out or causing to be carried out any task or request, or the consequences of any task or request, or steps of any method described herein.

The electronic device 102 may comprise a permanent storage (not depicted) in a form of one or more storage media and generally provides a place to store computer-executable instructions executable by a processor (not depicted). By way of example, the permanent storage may be implemented as a computer-readable storage medium including Read-Only Memory (ROM), hard disk drives (HDDs), solid-state drives (SSDs), and flash-memory cards.

The electronic device 102 comprises hardware and/or software and/or firmware (or a combination thereof), as is known in the art to execute a browser application 104. Generally speaking, the purpose of the browser application 104 is to enable the user 101 to access one or more web resources. The manner in which the browser application 108 is implemented is known in the art and will not be described herein. Suffice to say that the browser application 104 may be one of Google™ Chrome™, Yandex.Browser™, or other commercial or proprietary browsers.

Irrespective of how the browser application 104 is implemented, the browser application 104, typically, has a command interface (not depicted) and a browsing interface (not depicted). Generally speaking, the user 101 can access a given web resource by entering an address of the web resource (typically an URL or Universal Resource Locator, such as www.example.com) into the command interface, or by clicking a link in an email or in another web resource for being redirected to the given web resource, and in turn, content of the given web resource may be displayed in the browsing interface for the user 101.

Alternatively, the given user 101 may conduct a search using a search engine service (not depicted) to locate a resource of interest based on the user's search intent. The latter is particularly suitable in those circumstances, where the given user knows a topic of interest, but does not know the URL of the web resource she is interested in. The search engine typically returns a Search Engine Result Page (SERP) containing links to one or more web resources that are responsive to the user query. Again, upon the user clicking one or more links provided within the SERP, the user can open the required web resource.

In some embodiments of the present technology, the user 101 may make use of the browser application 104 for accessing an email application 150. Generally speaking, the email application 150 refers to one or more computer-implemented algorithms that enable the server 106 to provide email services for the user 101 of the electronic device 102. For example, the user 101 may have an email account associated with the email application 150. The user 101 may enter a URL associated with the email application 150 in the command interface of the browser application 104 and may access her email account with the email application 150.

In some embodiments of the present technology in addition to, or instead of, the electronic device 104 may be configured to execute a device-side email application (not depicted) associated with the (server-side) email application 150. Broadly speaking, the purpose of the device-side email application is to enable the user 101 to: browse a list of emails (both unread and read), read emails, open attachments, compose new emails, reply to emails, forward emails, delete emails, manage junk emails, assign categories to emails, organize emails into folders, create and access an address book and the like.

Irrespective of whether the user 101 makes use of the browsing application 104 and/or the device-side email application for accessing her email account, it is contemplated that the user 101 may be provided with an email interface for performing one or more actions on emails in her email account. The functionality of the email application 150 will be described in greater details herein further below.

### Email Interface

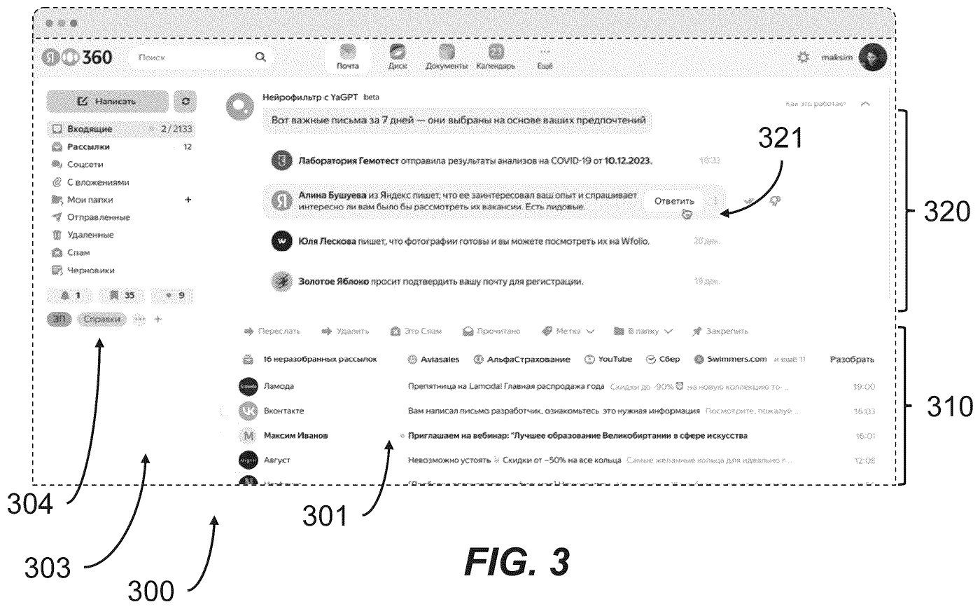

Withre reference to FIG. 3, there is depicted a snapshot 300 of the email interface 300 in accordance with at least some implmenetations of the present technology. Generally speaking, the purpose of the email interface is to allow user interactivity between a given user of the email application 150 (such as the user 101, for example) and emails in her email account.

In one non-limiting example, the email interface may comprise one or more bars, one or more menus, one or more buttons, and may also enable other functionalities for allowing user interactivity with emails. It should be noted that a variety of email interfaces may be envisioned without departing from the scope of the present technology.

In the non-limiting embodiment of FIG. 3, the email interface comprises a side bar 303 indicative of one or more email folders (pre-determined and/or personalized) associated with a given email account. For example, the side bar 303 may provide access to folders such as, but not limited to: “inbox” folder, “outbox” folder, “drafts” folder, “junk” or “spam” folder, “deleted” folder, and the like.

In the non-limiting embodiment of FIG. 3, the email interface comprises buttons 304 for performing various actions on emails. For example, the buttons 203 may be buttons such as, but not limited to: a “compose” button for composing a new email, a “send” button for sending a given email, a “save” button for saving a current version of a given email, a “read” button for indicating that a given email has been read or viewed by a given user, a “unread” button for indicating that a given email is unread or unviewed by a given user, a “spam” or “junk” button for indicating that a given email is to be categorized as a spam email and/or for indicating that the given email is to be transferred/moved to the “spam” folder, a “deleted” button for indicating that a given email is to be deleted and/or that the given email is to be transferred/moved to the “deleted” folder, and the like.

It is contemplated that the email interface may allow for other types of user interactivity with emails such as, but not limited to, “drag and drop” functionality for a given user to be able to select a given email from a first folder and to transfer/move the given email into a second folder in a seamless manner.

In the non-limiting embodiment of FIG. 3, the email interface comprises a first portion 310 for displaying emails from the inbox folder in a listed manner. A list of emails displayed by the first portion 310 comprises an indication of an email 301 received by the email account of the user 101. As it will become apparent from the description herein below, the server 106 may be configured to execute an “email engine” configured to inter alia process user data associated with the user 101 and email data associated with the email 301, and classify the email 301 as of a high importance class. To that end, the email engine may comprise a plurality of models for performing classification of one or more emails associated with a user account of the user 101.

In the non-limiting embodiment of FIG. 3, the email interface comprises a second portion 320 for displaying one or more email summaries generated based on one or more emails classified in a high importance class. A list of email summaries displayed by the second portion 320 comprises an indication of an email summary 321 generated based on the email 301. As it will become apparent from the description herein below, the server 106 may be configured to execute the email engine configured to inter alia process email data associated with the email 301, and generating the email summary 321 for the user 101.

In the non-limiting embodiment of FIG. 3, the email interface is used by the user 101 to provide indications of user actions. As it will become apparent from the description herein below, user-interactivity data may be generated and collected when a given user of the email application 150 performs one or more actions on her email(s) via the email interface.

Developers of the present technology have realized that user devices (e.g., computers, tablets, smartphones) may have limited CPU and/or memory, causing slow performance when handling large email volumes or complex content (e.g., large attachments, HTML emails). In some embodiments of the present technology, by displaying only summaries in the email UI, the computational load of user devices may be reduced. As a result, classification and summarization techniques disclosed herein may aid in reducing the need for the device to render or download full email bodies or attachments, improving overall performance and responsiveness of the email UI.

Developers of the present technology have realized that processing and/or rendering full emails (especially those containing multimedia content or complex HTML) can be resource-intensive for both servers and user devices. In some embodiments of the present technology, summarizing high importance emails on the server side and displaying only email summaries reduces computational strain on both the server and the client device. As a result, classification and summarization techniques disclosed herein may make the application run more smoothly, particularly on lower-powered devices or during peak traffic times.

Developers of the present technology have realized that limited network bandwidth or unstable internet connections can cause delays in downloading full emails, attachments, or syncing large inboxes. In some embodiments of the present technology, display of high importance email summaries may reduce the data transfer requirements by sending only the necessary information to the user, thus lowering bandwidth usage and speeding up load times. As a result, classification and summarization techniques disclosed herein may allow fetching on-demand full email content and attachments, further improving performance under low-bandwidth conditions.

Developers of the present technology have realized that high latency in retrieving or syncing emails from remote servers can lead to significant delays in delivering full email content to the user. In some embodiments of the present technology, high importance email summaries can be fetched and displayed faster than the entire email content, allowing users to stay informed of important messages without waiting for full email data to load. This improves user experience, especially in high-latency networks.

Developers of the present technology have realized that parsing and indexing large volumes of emails (such as for search, filtering, and/or sorting, for example) can place a high load on servers or local email clients, leading to delays and reduced performance. In some embodiments, processing and summarizing the content of high importance emails before it reaches the user 101 may reduce the need for intensive email parsing. As a result, email summaries can be indexed more efficiently than emails themselves, improving overall search and retrieval speed while lowering server processing load.

Developers of the present technology have realized that synchronizing email data between a server and client, especially across multiple devices or platforms, can be time-consuming and prone to errors. In some embodiments, there is provided methods and systems that may be sued to sync summaries first, and full content later, allows for faster synchronization. As a result, users can get more quicker updates with lower data transmission, while the full synchronization happens in the background.

Developers of the present technology have realized that large email attachments can cause delays in downloading, opening, and/or storing emails. In some embodiments, there is provided methods and systems that aid in displaying summaries with an overview of the attachment contents without necessarily downloading the full file, allowing users to decide if and when they want to download the attachment. As a result, unnecessary use of resources until the user chooses to engage with the content may be avoided. In other words, computational resources can be reduced at least until the user decides to engage with the content of the attachment.

### Communication Network

The electronic device 102 comprises a communication interface (not depicted) for two-way communication with a communication network 114 via a communication link (not numbered). In some non-limiting embodiments of the present technology, the communication network 114 can be implemented as the Internet. In other embodiments of the present technology, the communication network 114 can be implemented differently, such as any wide-area communication network, local area communications network, a private communications network and the like.

How the communication link is implemented is not particularly limited and depends on how the electronic device 102 is implemented. Merely as an example and not as a limitation, in those embodiments of the present technology where the electronic device 102 is implemented as a wireless communication device (such as a smart phone), the communication link can be implemented as a wireless communication link (such as, but not limited to, a 3G communications network link, a 4G communications network link, a Wireless Fidelity, or WiFi®, for short, Bluetooth®, or the like) or wired (such as an Ethernet based connection).

It should be expressly understood that implementations for the electronic device 102, the communication link and the communication network 114 are provided for illustration purposes only. As such, those skilled in the art will easily appreciate other specific implementational details for the electronic device 102, the communication link and the communication network 114. As such, by no means the examples provided hereinabove are meant to limit the scope of the present technology.

### Web Servers

The system 100 further includes a plurality of web servers 120 coupled to the communication network 114. A given one of the plurality of web servers 120 can be implemented as a conventional computer server. In an example of an embodiment of the present technology, the given web server can be implemented as a Dell™ PowerEdge™ Server running the Microsoft™ Windows Server™ operating system. Needless to say, the given web server can be implemented in any other suitable hardware and/or software and/or firmware or a combination thereof.

In some embodiments of the present technology, and generally speaking, the plurality of web servers 120 function as repositories for web resources. In the context of the present specification, the term “web resource” refers to any network resource (such as a web page, web site), which its content is presentable visually by the electronic device 102 to the user, via the browser application 104, and associated with a particular web address (such as a URL).

A given web resource hosted by one or more of the plurality of web servers 210 may be accessible by the electronic device 102 via the communication network 114, for example, by means of the user typing in the URL in the browser application 104 or executing a web search using the search engine (not depicted). Needless to say, in some cases, a given web server amongst the plurality of web servers 120 may host one or more web resources, while in other cases, a given web resource may be hosted by one or more web servers amongst the plurality of web servers 120.

As it will become apparent from the description herein further below, one or more of the plurality of web servers 120 may be configured to host other server-side email applications. In one non-limiting example, the one or more of the plurality of web servers 120 may be under control of one or more email service providers.

### Server

The system 100 further includes a server 106 coupled to the communication network 114. The server 106 can be implemented as a conventional computer server. In an example of an embodiment of the present technology, the server 106 can be implemented as a Dell™ PowerEdge™ Server running the Microsoft™ Windows Server™ operating system. Needless to say, the server 106 can be implemented in any other suitable hardware and/or software and/or firmware or a combination thereof. In the depicted non-limiting embodiment of the present technology, the server 106 is a single server. In alternative non-limiting embodiments of the present technology, the functionality of the server 106 may be distributed and may be implemented via multiple servers.

The implementation of the server 106 is well known. However, briefly speaking, the server 106 comprises a communication interface (not depicted) structured and configured to communicate with various entities (such as the electronic device 102 and other devices potentially coupled to the communication network 114) via the communication network 114.

Similar to the electronic device 102, the server 106 comprises one or more storage media and generally provides a place to store computer-executable program instructions executable by one or more processors (not depicted) of the server 106. By way of example, the one or more storage media may be implemented as tangible computer-readable storage medium including Read-Only Memory (ROM) and/or Random-Access Memory (RAM) and may also include one or more fixed storage devices in the form of, by way of example, hard disk drives (HDDs), solid-state drives (SSDs), and flash-memory cards.

In some embodiments, the server 106 can be operated by the same entity that has provided the afore-described browser application 104 and/or the afore-described device-side email application. For example, if the browser application 104 is a Yandex.Browser™, the server 106 can be operated by Yandex™ LLC. In another example, if the device-side email application is Yandex.Mail™, the server 106 may also be operated by Yandex™ LLC. In alternative embodiments, the server 106 can be operated by an entity different from the one who has provided the aforementioned browser application 104.

In accordance with non-limiting embodiments of the present technology, the server 106 may be configured to host the (server-side) email application 150. As mentioned above, the purpose of the email application 150 is to provide email services to one or more users (including the user 101) associated with email accounts of the email application 150. It should be noted that the server 106 may be under control of an email service provider.

Again, the email application 150 may be accessible by the electronic device 102 by entering the associated URL (such as mail.yandex.ru, or the like) into the command interface of the browser application 104 (or clicking a hyperlink associated therewith) and/or by executing the afore-mentioned device-side email application. Once the email application 150 is accessed, the electronic device 102 may be configured to display the email interface to the user 101 for enabling user interactivity between the user 101 and emails in her email account. In some embodiments of the present technology, the user 101 may need to “log in” to her email account for being displayed with the email interface.

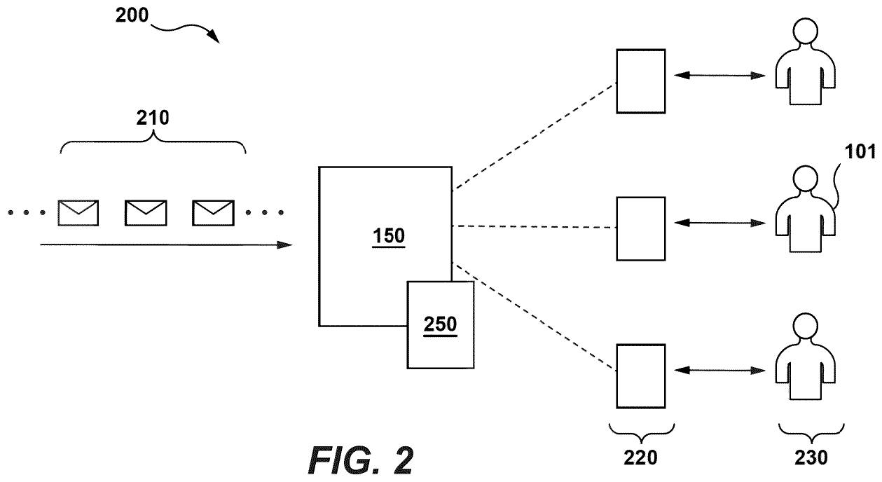

In at least some embodiments of the present technology, the server 106 hosting the email application 150 may act as an email transfer agent and, therefore, may be configured to transfer emails to and from the senders of e-mails and recipients of emails (such as the user 101 of the electronic device 102, for example). How the email application 150 can be used for providing email services will be described in greater details herein further below with reference to FIG. 2.

### Database

The server 106 has access to a database 108. Broadly speaking, the email application 150 may make use of the database 108 for providing email services to its users. For example, the server 106 may be configured to maintain, within the database 108, emails destined for the user 101 associated with the electronic device 102. It should be noted that to the extent that the user 101 of the electronic device 102 has a pending email destined for her (in a sense that the user accesses her email interface for the purposes of checking emails destined to her), the user 101 can be thought of as an email recipient in the sense that she is the intended recipient of the pending email.

It is contemplated that the server 106 may be configured to access the database 108 to retrieve emails destined for the user 101 of the electronic device 102, for example, based on at least the destination email address associated with the user 101 of the electronic device 102 by matching it to the destination addresses stored within the “To” field of the plurality of emails stored at the database 108.

In some embodiments, the database 108 may be configured to store, in association with emails, an indication of some or all of the aforementioned message fields. In some embodiments, database 108 can also maintain the following information about the emails: receipt date, read date, user ID, time zone of the e-mail message recipient, action the user has taken in association with the e-mail message (if any), the type of electronic device on which such action was executed, platform of such electronic device and/or its operating system, sequential number of the emails within the inbox, socio-demographic information about the user and the like.

The database 108 may also store behavioral data associated with interactions of users of the email application 150 with emails destined to or originated from the users of the e-mail application 150. In some embodiments, the behavioral data may be stored in the database 108 in association with respective email accounts. For example, the database 108 may store a list of email categories and/or folders (pre-determined and/or personalized) associated with a given email account of the email application 150, such as but not limited to: “personal correspondence”, “financial”, “advertising”, “spam”, “others” and the like. Needless to say, the examples provided herein are meant to be non-limiting and non-exhaustive and other categories (as well as number of pre-set categories) can be used. In another example, behavioral data may include data indicative of user-interactivity between a given user and her emails and may be stored in the database 108 in association with the respective email account.

### Server-Side Email Application

The functionality of the email application 150 will now be described with reference to FIG. 2. There is depicted a representation 200 of how the server 106 hosting the email application 150 may be configured to process a plurality of emails 210.

As depicted in FIG. 2, the email application 150 hosts a plurality of email accounts 220 and where each one of the plurality of email accounts 220 is respectively associated with a unique email address. For example, a plurality of users 230 (including the user 101) may have respective one or more email accounts with the email application 150 for, generally speaking, receiving, sending, and storing emails. As such, the plurality of emails 210 may be received by the server 106 from one or more email senders and the server 106 is configured to inter alia provide the plurality of emails to the plurality of email accounts 220. It should be noted that in at least some embodiments of the present technology, email senders may include users from the plurality of users 230 of the email application 150. Needless to say, the server 106 may also be configured to send emails from the plurality of email accounts 220 of the email application 150 to respective recipient addresses of those emails.

It should be noted that a given email from the plurality of emails 210 received by the server 106 may comprise header data and content data. Broadly speaking, header data is used for email transfer purposes and generally includes information identifying the subject, sender and recipient of a given email. For example, header data may comprise information about (i) the sender's email address associated with a “From” field of the given email, (ii) recipient email address(es) associated with a “To” field, “Cc” field and/or “Bcc” field of the given email, (iii) the title associated with the “Subject” field of the given email, (iv) and the like.

The content data of a given email generally includes content that the sender wishes to provide to the recipient(s) via the given email. For example, the content data of the given email may comprise information about the body of the given email, and one or more files (if any) attached to the given email such as web pages, audio files, video files, image files, text files, and HTML markup. Needless to say, the given email may comprise additional data in addition to header data and content data (such as email metadata, for example), without departing from the scope of the present technology.

When a given email from the plurality of emails 210 is received by the server 106, the server 106 may be configured to process the header data of the given email and determine which email account of the email application 150 is associated with the recipient address in the header data of the given email. The server 106 may thus determine which email of the plurality emails 210 is to be provided to which email account amongst the plurality of email accounts 220.

For example, assuming that the recipient address from the header data of the given email matches the email address of the email account associated with the user 101, the server 106 may store the given email in the database 108 in association with the inbox folder of that email account. As a result, when the user 101 accesses her email account, the email interface will be indicative of that that the inbox folder includes the given email.

Needless to say, the user 101 may use the email interface to interact with the given email. For example, the user 101 may decide to “read” the given email. In some cases, the user 101 may implicitly “read” the given email by opening the given email to see the content thereof. In other cases, the user 101 may explicitly “read” the given email by actuating the “read” button on the email interface. In another example, the user 101 may decide to “delete” the given email. In some cases, the user 101 may implicitly “delete” the given email by dragging and dropping the given email from the inbox folder into the “deleted” folder or “trash” folder. In other cases, the user 101 may explicitly “delete” the given email by actuating the “delete” or “trash” button on the email interface. In a further example, the user 101 may decide that the given email is spam. In some cases, the user 101 may implicitly categorize the given email as a spam email by dragging and dropping the given email from the inbox folder into the “spam” folder or “trash” folder. In other cases, the user may explicitly categorize the given email as a spam email by actuating the “spam” or “junk” button on the email interface.

In at least some embodiments of the present technology, it is contemplated that implicit and/or explicit user interactions between the given email and the user 101 may be collected and stored in the database 108 in association with the given email. It should be noted that the above examples of implicit and explicit user interactions between the given email and the user 101 are non-exhaustive and that data indicative of other user interactions may similarly be collected by the server 106 and stored in the database 108 in association with the given email.

As it will become apparent from the description herein further below, developers of the present technology have devised methods and systems that allow leveraging user-interactivity data between users and emails for ameliorating email categorization performance of the email application 150.

Returning to the description of FIG. 2, the email application 150 may comprise an email engine 250 configured to inter alia, acquire email data, acquire user data, process email data and user data to classify emails, and generate emails summaries based on email content of emails of a given class. To that end, the email engine 250 may be configured to employ a plurality of Machine Learning (ML) models.

In some embodiments, the email engine 250 is configured to train and/or use one or more Deep Structured Semantic Model (DSSM). Broadly, a DSSM is a deep learning model used for semantic matching in tasks like information retrieval, ranking, and recommendation systems. A DSSM is designed to map high-dimensional inputs (such as text, queries, or documents) into low-dimensional semantic spaces, where semantically similar inputs have representations that are close to each other in this space.

In some implementations, the DSSM architecture comprises two neural networks that independently transform a pair of inputs into corresponding low-dimensional semantic vectors. Raw inputs such as text can be preprocessed by an input layer (e.g., tokenized, transformed into n-grams, or embedded) before entering the model. The DSSM may use a series of fully connected layers (feedforward neural networks) with non-linear activations (e.g., ReLU) to transform the input vectors into low-dimensional dense vectors (embeddings). In some embodiments, a given DNN may be dedicated to processing a respective input type. After mapping both inputs to their embeddings, a cosine similarity between two vectors may be computed to measure the degree of semantic similarity. The higher the similarity, the better the semantic match between the two inputs.

It is contemplated that a given DSSM is configured to learn a transformation such that semantically related inputs are close in the vector space, and unrelated inputs are far apart. The DSSMs may be trained using supervised learning. During the training a DSSM, the first step is feeding to the DSSM positive and/or negative training examples. For example, a given DSSM may be trained to assign higher similarity scores to positive example pairs and lower scores to negative example pairs. A cross-entropy loss and/or ranking loss based on the similarity scores may be employed. The model parameters (weights of the DNN layers, for example) may be optimized using backpropagation and gradient descent (e.g., stochastic gradient descent). The gradients are computed with respect to the loss, and the parameters are updated accordingly to minimize the loss.

In some embodiments, the email engine 250 is configured to train and/or use one or more Gradient Boosted Decision Tree (GBDT) models. Broadly, GBDT is an ensemble learning method that builds models by combining the predictions of multiple decision trees, where each tree is trained to correct the errors made by the previous trees. The goal is to improve model accuracy by sequentially adding trees that minimize the residual errors (the difference between the predicted and actual values). For example, this can be achieved by optimizing a loss function via gradient descent.

It is contemplated that a GBDT may be trained using a Categorical Boosting (CatBoost) technique. The CatBoost algorithm may help in building GBDT models that minimize overfitting while providing accuracy in regression or classification tasks. CatBoost may be used for handling categorical variables without requiring extensive data preprocessing. CatBoost may be used for reducing target leakage and/or overfitting when dealing with categorical features.

In some implementations, CatBoost-based GBDT model can be trained and applied for solving classification tasks. In classification tasks (e.g., binary or multiclass classification), the model outputs probability estimates for each class. The class with the highest probability is selected as the predicted class.

In some embodiments of the present technology, the email engine 250 is configured to train and/or use one or more generative models. Broadly, a generative model may be configured to summarize content and operates by leveraging natural language processing (NLP) techniques, typically built on transformer architectures like GPT or BERT. The generative model is trained on vast datasets containing diverse text sources and fine-tuned to identify and extract key information from input content. During summarization, the generative model processes the text and/or other input data by encoding its semantic and syntactic structures, and then generates a condensed version that retains essential ideas while discarding redundant or less relevant information. The model can be configured to focus on specific types of summaries, such as abstractive (rephrasing content into a shorter form) or extractive (identifying and extracting key phrases or sentences). Additionally, mechanisms such as attention layers allow the model to focus on the most important parts of the input, ensuring the summary is coherent, contextually accurate, and concise.

In some implementations, the generative model is a YaGPT™ model which is built on the architecture of a GPT model, while using PyTorch™ to implement its components. The process begins with tokenization, where the input text is broken down into individual tokens-small units such as words or subwords. The model may handle the text in numerical form, and tokenization transforms raw text into manageable elements for further processing. Following tokenization, the tokens pass through the embedding layer. The embedding layer converts each token into a dense vector representation, which captures semantic meaning in a high-dimensional space. The embedding provides the model with a structured way to interpret the text in numerical form, allowing the next stages to process the information efficiently. The model may perform positional encoding to recognize the order of tokens in a sequence. Positional encodings are added to the embeddings to retain the sequence's structure, which may be beneficial for tasks that require an understanding of word order. This allows the model to distinguish between different positions in the sequence, ensuring that it generates contextually appropriate text. Additionally, data processing happens within a “transformer decoder” component. The transformer decoder component comprises several layers of self-attention mechanisms and feed-forward networks. The self-attention mechanism allows the model to focus on different parts of the sequence when predicting the next token, improving the generation of contextually relevant text. As the tokens move through the decoder layers, the model refines its predictions based on the previously generated tokens and the context they form. The processed information is then passed to the output layer, where the model generates the probabilities for the next token in the sequence. Based on these probabilities, the model outputs the most likely token, completing the process of generating text. These components allow the YaGPT™ model to generate coherent, contextually appropriate, and/or stylistically aligned with the model's training data.

### Email Classification

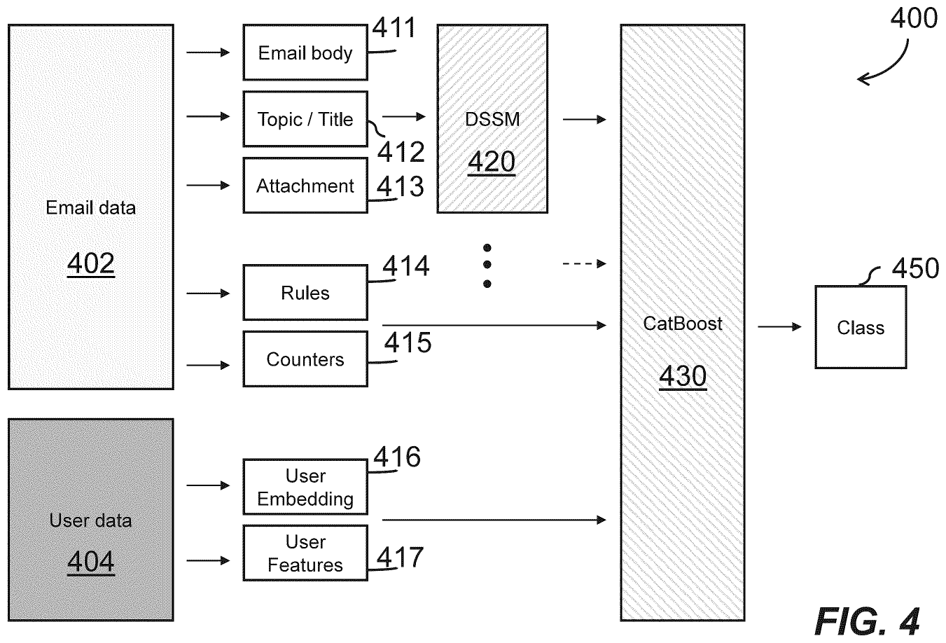

With reference to FIG. 4, there is depicted a schematic illustration of an email classification process 400 executable by the email engine 250 of the server 106. Broadly, the email engine 250 is configured to employ a combination of ML models for performing email classification.

In this embodiment, the server 106 may acquire email data 402 associated with a given email. It should be noted that the server 106 may be configured to process the email data 402 in an encrypted format and/or in a decrypted format, without departing from the scope of the present technology. The email data 402 may comprise data indicative of an email body 411, data indicative of a topic and/or a title 412, data indicative of attachments 413, and the like. Optionally, the email data 402 may be analyzed using rule-based and/or counter based techniques for extracting rule data 414 and counter data 415. Rules may be applied on the email data 402 for determining if the email contains a string such as “urgent”, “important”, “due date”, “sensitive”, and the like. Counters may be applied on the email data 402 for determining a number of emails in an email chain containing the given email, a number of emails from the email chain that were archived and/or classified in a specific folder, and the like. In some embodiments, the email data 402 may be encrypted data.

In this embodiment, the server 106 may acquire user data 404 associated with a given user. The user data 404 may comprise user data of the given user stored in the database 108. The user data may comprise a user embedding 416 and user features 417, and the like. In some embodiments, the user data 404 may be encrypted data.

In this embodiment, at least a portion of the email data 402 is provided to a DSSM 420 for processing and generation of an email-based processed information for a CatBoost-based model 430. Developers have realized that providing predictions made by one or more DSSMs based on email data may allow the CatBoost-based model 430 to consider email-based processed information during the classification process.

In some embodiments of the present technology, the email engine 250 may be configured to process at least a portion of the email data 402 using one or more DSSMs for generating email-based processed information. The email engine 250 may also be configured to process the email-based processed information in combination with at least a portion of the user data 404 using one or more GBDT models for performing classification of the given email for the given user.

It is contemplated that a plurality of DSSMs may be used as respective action-dedicated DSSMs for predicting the likelihood of the given user performing a specific user action on the given email. Such a plurality of action-dedicated DSSMs may be used to generate a plurality of action-based processed information to be further used by a GBDT model for performing classification of the given email for the given user. At least some non-limiting examples of user actions comprise, but are not limited to, reading the email, labelling the email as spam, labelling the email as favorite, opening an attachment, clicking a link in the email, deleting the email without a reading action, mass reading action such as when multiple unread actions are performed on a set of email including the email, inactivity action such as when the email has not been interactive with for a pre-determine amount of time, moving the email to an other email folder.

In one non-limiting example, the DSSM 420 may be configured to process the email body 411, the title 412, and the attachment 413, to generate a prediction value indicative of a likelihood that the given user reads the given email. In this non-limiting example, the prediction value is an email-based processed information associated with a first type of user actions (i.e., “reading” action) to be potentially performed by the given user on the given email.

In this non-limiting example, the email-based processed information generated by the DSSM 420, as well as other email-based data such as the rules data 414 and the counters data 415, and the user data such as the user embedding 416 and the user features 417, are provided to the CatBoost-based GBDT model 430. During inference, the CatBoost-based GBDT model 430 uses the inputted data to determine whether the given email is of a high importance to the given user, or otherwise of a low importance to the given user. Developers of the present technology have realized that provision of email-based processed information indicative of likelihood(s) of the given user performing respective user action(s) on the given email may ameliorate the email classification capability of the email engine 250.

In some embodiments of the present technology, the email-based processed information may be associated with respective weight factors when inputted into the CatBoost-based GBDT model 430. In one non-limiting example, for the user action being “opening and reading” the given email, the corresponding prediction value may be associated with a weight “1”. In an other non-limiting example, for the user action being “reading and forwarding” the given email, the corresponding prediction value may be associated with a weight “2”. In an additional non-limiting example, for the user action being “reading and labelling as important” the given email, the corresponding prediction value may be associated with a weight “3”. Higher weights may allow the CatBoost-based GBDT model 430 to in a sense pay attention more to some email-based processed information than others when making the classification decision.

During training, the CatBoost-based GBDT model 430 may use the user actions log (records of the user past activities and statistics) as a data source indicative of user behavior with different emails. The CatBoost-based GBDT model 430 may also be trained to take into account a variety of counters and rule-based indicators to determine whether the given email is of high importance or otherwise of a low importance. In one non-limiting embodiment, the CatBoost-based GBDT model 430 may be trained using target data indicative of whether a training email has been opened or marked as viewed, the training email has been labeled as a spam email, the training email has been deleted, etc. In some embodiments, a plurality of training parameters may be associated with respective timestamps so that the CatBoost-based GBDT model 430 can consider temporal information associated with different user actions during the classification information.

In this embodiment, the CatBoost-based GBDT model 430 is configured to generate a classification value 450 indicative of a class of the given email. In case of the classification value 450 being indicative of a high importance class for the given email, the email engine 250 may be configured to employ a generative model on the email data 402 (potentially encrypted) for generating an email summary for the given email. The email engine 250 may then be configured to trigger display of the email summary for the given user in a dedicated email summary portion of the email UI. In case of the classification value 450 being indicative of a low importance class for the given email, the email engine 250 may be configured not to generate an email summary for the given email.

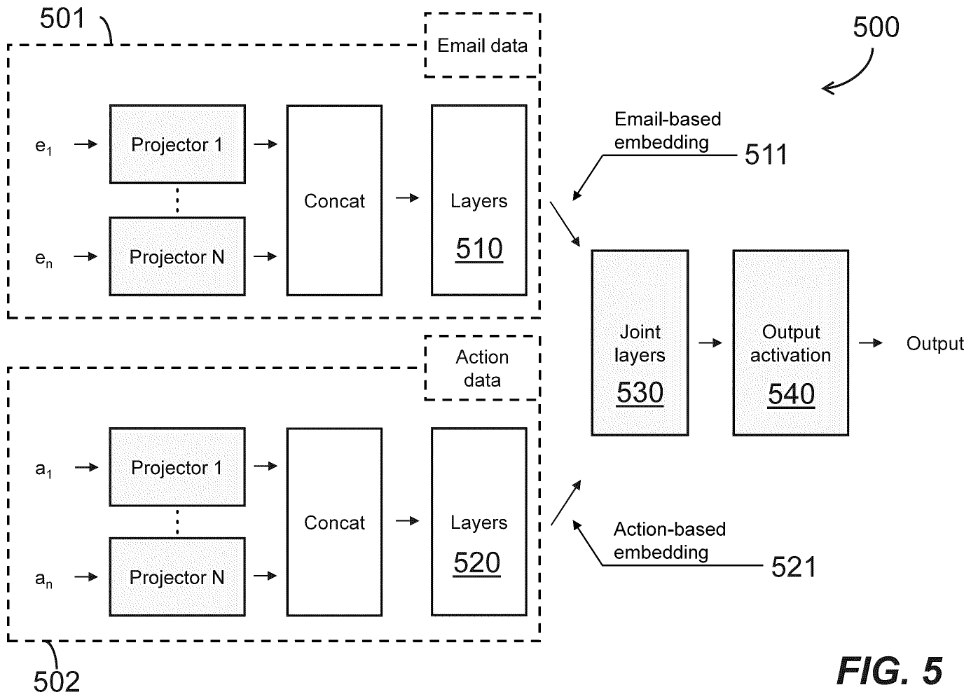

With reference to FIG. 5, there is depicted a schematic illustration of a training process 500 of the DSSM 420. The DSSM 420 can be trained based on email data 501, and on action data 502. The email data 501 such as email body content, title content, attachment content, for example, may be concatenated and inputted into first layers 510. The first layers 510 are configured to generate an email-based embedding 511. The action data 502 may be concatenated and inputted into second layers 520. The second layers 520 are configured to generate an action embedding 521. Joint layers 520 are configured to acquire the email-based embedding 511 and the action-based embedding 521 for further processing. An output activation layer 540 may acquire the processed data from the joint layers 530 and generate an output. Following such a training procedure a number of training examples, the DSSM 420 may be configured to determine a predicted output indicative of a provability that a given user performs a given suer action on a given email.

In some embodiments, the training process 500 may be performed in accordance with a following expression:

$$0.5 * ( Y > 0 ) T * [ log ( diag [ softmax ( EA ) ] ) + log ( diag [ softmax ( AE ) ] ) ] \qquad ( 1 )$$

where EA is a matrix where the rows correspond to email data, the columns to action data, and each cell (i, j) contains the network's prediction regarding the match between email i and action j, AE is a matrix where the rows correspond to action data, the columns to email data, and each cell (i, j) contains the network's prediction regarding the match between action i and email j. It can be said that by iterating through all input pairs from the batch samples (without removing duplicates), a matrix can be generated where the scores of positive samples are on a diagonal of the matrix, and the rest are the scores of false samples. The loss function ensures that the diagonal elements are greater than the other elements. This can be done only for the diagonal values of those samples whose target is greater than “0” (thus, the loss can combine both pairwise modes: if the dataset places a clicked and unclicked sample from the same input next to each other, the loss will learn to identify false samples and distinguish the clicked one from the unclicked one). For each row, the target can be a vector of zeros, with one unit in the diagonal element (if the target >0). A softmax can then be applied, and cross-entropy is calculated. The same can be performed for each column. The result can be 0.5*(loss on rows+loss on columns).

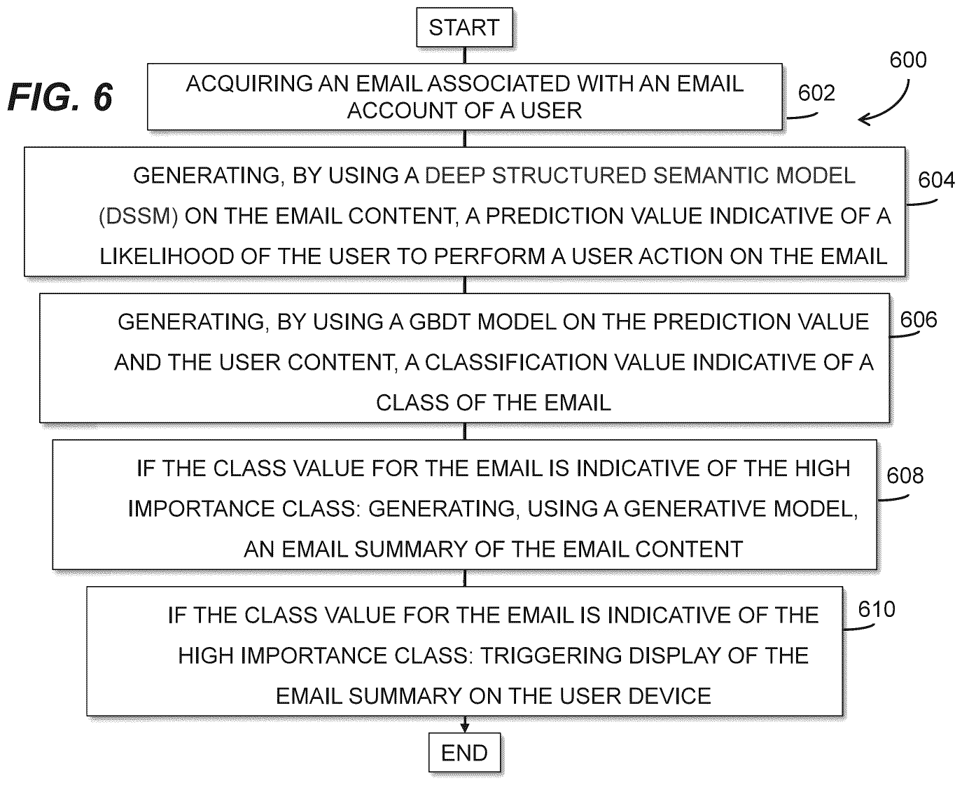

In some embodiments of the present technology, the server 106 is configured to execute a computer-implemented method for providing email data to the device 102. With reference to FIG. 6, there is depicted a scheme-block representation of a method 600 executable by the server 106. Various steps of the method 600 will now be described.

Step 602: Acquiring an Email Associated with an Email Account of a User

The method 602 begins with the server 106 acquiring an email associated with an email account of a user. For example, the server 106 may acquire an email associated with the email account of the user 102.

The email comprises email data. For example, the email data may comprise a title, email body, attachment(s), metadata, and the like. In at least some embodiments the email data may be encrypted.

### Step 604: Generating, by Using a Deep Structured Semantic Model (Dssm) on the Email Content, a Prediction Value Indicative of a Likelihood of the User to Perform a User Action on the Email

The method 600 continues to step 604 with the server 106 generating by using a given DSSM on the email content, of the email acquired during the step 606, a prediction value indicative of a likelihood of the user to perform a user action.

In some embodiments of the present technology, the email engine 250 may be configured to process at least a portion of the email data 402 using one or more DSSMs for generating email-based processed information. The email engine 250 may also be configured to process the email-based processed information in combination with at least a portion of the user data 404 using one or more GBDT models for performing classification of the given email for the given user.

It is contemplated that a plurality of DSSMs may be used as respective action-dedicated DSSMs for predicting the likelihood of the given user performing a specific user action on the given email. Such a plurality of action-dedicated DSSMs may be used to generate a plurality of action-based processed information to be further used by a GBDT model for performing classification of the given email for the given user. At least some non-limiting examples of user actions comprise, but are not limited to, reading the email, labelling the email as spam, labelling the email as favorite, opening an attachment, clicking a link in the email, deleting the email without a reading action, mass reading action such as when multiple unread actions are performed on a set of email including the email, inactivity action such as when the email has not been interactive with for a pre-determine amount of time, moving the email to an other email folder.

In one non-limiting example, the DSSM 420 may be configured to process the email body 411, the title 412, and the attachment 413, to generate a prediction value indicative of a likelihood that the given user reads the given email. In this non-limiting example, the prediction value is an email-based processed information associated with a first type of user actions (i.e., “reading” action) to be potentially performed by the given user on the given email.

In some embodiments, a given type of user actions comprises at least one of reading the email, labelling the email as spam, labelling the email as favorite, opening an attachment, clicking a link in the email.

In some embodiments, an other (e.g., a second) DSSM may be also employed in addition to the DSMM 420, In these embodiments, the server 106 may be configured to generate, by using the other DSSM on the email content, an other prediction value indicative of a likelihood of the given user to perform an other user action on the email. The other user action is of an other given type, the given type for the DSSM 420 being different from the other given type, the other DSSM has been trained on the other given type of user actions.

### Step 606: Generating, by Using a Gbdt Model on the Prediction Value and the User Content, a Classification Value Indicative of a Class of the Email

The method continues to step 606 with the server 106 configured to generate, by using a GBDT model, on the prediction value and the user content, a classification value indicative of a class of the email.

In some embodiments, the email-based processed information generated by the DSSM 420 and/or other DSSM(s) which includes a plurality of action-dedicated predictions, as well as other email-based data such as the rules data 414 and the counters data 415, and the user data such as the user embedding 416 and the user features 417, may be provided to the CatBoost-based GBDT model 430.

During inference, the CatBoost-based GBDT model 430 is configured to use the inputted data to determine whether the given email is of a high importance to the given user, or otherwise of a low importance to the given user. In this embodiment, the CatBoost-based GBDT model 430 is configured to perform binary classification. Developers of the present technology have realized that provision of email-based processed information indicative of likelihood(s) of the given user performing respective user action(s) on the given email may ameliorate the email classification capability of the email engine 250.

In some embodiments of the present technology, the email-based processed information may be associated with respective weight factors when inputted into the CatBoost-based GBDT model 430. In one non-limiting example, for the user action being “opening and reading” the given email, the corresponding prediction value may be associated with a weight “1”. In an other non-limiting example, for the user action being “reading and forwarding” the given email, the corresponding prediction value may be associated with a weight “2”. In an additional non-limiting example, for the user action being “reading and labelling as important” the given email, the corresponding prediction value may be associated with a weight “3”. Higher weights may allow the CatBoost-based GBDT model 430 to in a sense pay attention more to some email-based processed information than others when making the classification decision.

### Step 608: If the Class Value for the Email is Indicative of the High Importance Class: Generating, Using a Generative Model, an Email Summary of the Email Content

The method 600 continues to step 608 with the server 106 configured to, if the class value of the email is indicative of the high importance class, generate using a generative model an email summary of the email content. The email summary may comprise a summary of an email attachment of the email. The generative model may be a given GPT-based model.

### Step 610: If the Class Value for the Email is Indicative of the High Importance Class: Triggering Display of the Email Summary on the User Device

The method 600 continues to step 610 with the server 106 configured to trigger display of the email summary on the device 102. In some embodiments, the email summary comprising a summary of the attachment content may be provided to the device 102 before and/or instead of the email content including the attachment content.

It is contemplated that the server 106 may perform classification and summarization techniques disclosed herein for performing independent classification of acquired emails from one another.

Modifications and improvements to the above-described implementations of the present technology may become apparent to those skilled in the art. The foregoing description is indented to be exemplary rather than limiting. The scope of the present technology is therefore intended to be limited solely by the scope of the appended claims.

While the above-described implementations have been described and shown with reference to particular steps performed in a particular order, it will be understood that these steps may be combined, sub-divided, or re-ordered without departing from the teachings of the present technology. Accordingly, the order and grouping of the steps is not a limitation of the present technology.

1. A method of providing email data, the method executable by a server communicatively coupled with a user device, the method comprising:
acquiring an email associated with an email account of a user, the server having access to email content of the email and user content of the user;
generating, by using a Deep Structured Semantic Model (DSSM) on the email content, a prediction value indicative of a likelihood of the user to perform a user action on the email, the user action being of a given type, the DSSM has been trained on the given type of user actions;
generating, by using a GBDT model on the prediction value and the user content, a classification value indicative of a class of the email, the class being one of a high importance class and a low importance class;
if the class value for the email is indicative of the high importance class:
generating, using a generative model, an email summary of the email content; and
triggering display of the email summary on the user device.

2. The method of claim 1, wherein the method further comprises:
storing the email summary for display of the email summary to the user.

3. The method of claim 1, wherein the email content comprises at least one of an email body, an email title, an email attachment.

4. The method of claim 1, wherein the email summary comprises a summary of the email attachment, and wherein the triggering display of the email summary is executed prior to transmitting the email attachment to the user device.

5. The method of claim 1, wherein the given type of user actions comprises at least one of reading the email, labelling the email as spam, labelling the email as favorite, opening an attachment, clicking a link in the email.

6. The method of claim 1, wherein the user content comprises a user embedding generated based on user behavioral data.

7. The method of claim 1, wherein the method further comprises:
generating, by using an other DSSM on the email content, an other prediction value indicative of a likelihood of the given user to perform an other user action on the email,
the other user action being of an other given type, the given type being different from the other given type, the other DSSM has been trained on the other given type of user actions instead of the given type of user actions;
and wherein the generating the classification value further comprises generating the classification further using the other prediction value.

8. The method of claim 1, wherein the generating the classification value further comprises generating the classification further using at least one of rule-based and counter-based indicators generated based on the email content.

9. The method of claim 1, wherein the method further comprises:
acquiring a second email associated with the email account of the user, the server having access to second email content of the second email and the user content of the user;
generating, by using the DSSM on the second email content, a second prediction value indicative of a likelihood of the user to perform the user action on the second email, the user action being of the given type,
the generating the second prediction value for the second email being performed independently form the generating the prediction value for the email;
generating, by using a GBDT model on the second prediction value and the user content, a second classification value indicative of a class of the second email,
the generating the second classification value for the second email being executed independently from the generating the classification value for the email;
if the class value for the second email is indicative of the high importance class:
generating, using the generative model, a second email summary of the second email content; and
triggering display of the second email summary on the user device.

10. The method of claim 1, wherein the generative model is a Generative Pre-Trained Transformer (GPT) model.

11. A server for providing email data, the server communicatively coupled with a user device, the server being configured to:
acquire an email associated with an email account of a user, the server having access to email content of the email and user content of the user;
generate, by using a Deep Structured Semantic Model (DSSM) on the email content, a prediction value indicative of a likelihood of the user to perform a user action on the email, the user action being of a given type, the DSSM has been trained on the given type of user actions;
generate, by using a GBDT model on the prediction value and the user content, a classification value indicative of a class of the email, the class being one of a high importance class and a low importance class;
if the class value for the email is indicative of the high importance class:
generate, using a generative model, an email summary of the email content; and
trigger display of the email summary on the user device.

12. The server of claim 11, wherein the server is configured to:
store the email summary for display of the email summary to the user.

13. The server of claim 11, wherein the email content comprises at least one of an email body, an email title, an email attachment.

14. The server of claim 11, wherein the email summary comprises a summary of the email attachment, and wherein the triggering display of the email summary is executed prior to transmitting the email attachment to the user device.

15. The server of claim 11, wherein the given type of user actions comprises at least one of reading the email, labelling the email as spam, labelling the email as favorite, opening an attachment, clicking a link in the email.

16. The server of claim 11, wherein the user content comprises a user embedding generated based on user behavioral data.

17. The server of claim 11, wherein the server is configured to:
generate, by using an other DSSM on the email content, an other prediction value indicative of a likelihood of the given user to perform an other user action on the email,
the other user action being of an other given type, the given type being different from the other given type, the other DSSM has been trained on the other given type of user actions instead of the given type of user actions;
and wherein to generate the classification value further comprises the server configured to generate the classification further using the other prediction value.

18. The server of claim 11, wherein to generating the classification value further comprises the server configured to generate the classification further using at least one of rule-based and counter-based indicators generated based on the email content.

19. The server of claim 11, wherein the server is configured to:
acquire a second email associated with the email account of the user, the server having access to second email content of the second email and the user content of the user;
generate, by using the DSSM on the second email content, a second prediction value indicative of a likelihood of the user to perform the user action on the second email, the user action being of the given type,
the generating the second prediction value for the second email being performed independently form the generating the prediction value for the email;
generate, by using a GBDT model on the second prediction value and the user content, a second classification value indicative of a class of the second email,
the generating the second classification value for the second email being executed independently from the generating the classification value for the email;
if the class value for the second email is indicative of the high importance class:
generate, using the generative model, a second email summary of the second email content; and
trigger display of the second email summary on the user device.

20. The server of claim 11, wherein the generative model is a Generative Pre-Trained Transformer (GPT) model.
